(19) United States
(12) Patent Application Publication
(10) Pub. No.: US 2023/0025126 A1
(43) Pub. Date: Jan. 26, 2023

(54) VIRTUALIZATION LAYER ASSISTED UPGRADING OF IN-GUEST AGENTS

(71) Applicant: VMWARE, INC., Palo Alto, CA (US)

(72) Inventors: SACHIN SHINDE, Pune (IN); Goresh Musalay, Bangalore (IN); Tanay Ganguly, Bangalore (IN); Zubraj Singha, Bangalore (IN); Kashish Bhatia, Bangalore (IN)

(21) Appl. No.: 17/496,798

(22) Filed: Oct. 8, 2021

(30) Foreign Application Priority Data
Jul. 23, 2021 (IN) 202141033131

(51) Int. Cl. G06F 9/455; G06F 8/65; G06F 9/445

(52) U.S. Cl. CPC G06F 9/45558; G06F 8/65; G06F 9/44594; G06F 2009/45583; G06F 9/4401

(57) ABSTRACT

A system may include a host computer, a VCI running on the host computer, a virtualization layer executing in the host computer to support the VCI, and an in-guest agent executing in the VCI. The virtualization layer receives a message including metadata about a first memory region to be copied and an indication of loading of an upgraded version of the in-guest agent. Further, the virtualization layer copies data from the first memory region to a second memory region. Furthermore, the virtualization layer receives information about an entry point of the upgraded version from the in-guest agent. Also, the virtualization layer receives a request to register the entry point from the upgraded version and verifies the request based on the information about the entry point. Upon verifying the request, the virtualization layer enables the upgraded version to copy the data from the second memory region.

### RELATED APPLICATION

Benefit is claimed under 35 U.S.C. 119(a)-(d) to Foreign Application Serial No. 202141033131 filed in India entitled “VIRTUALIZATION LAYER ASSISTED UPGRADING OF IN-GUEST AGENTS”, on Jul. 23, 2021, by VMware, Inc., which is herein incorporated in its entirety by reference for all purposes.

### TECHNICAL FIELD

The present disclosure relates to a virtualized computing environment, and more particularly to methods, techniques, and systems to upgrade an in-guest agent executing in a virtual computing instance (VCI) in the virtualized computing environment.

### BACKGROUND

Virtual computing instances (VCIs) may provide a guest operating system (OS) with a virtual execution platform including virtual hardware subsystems configured to emulate corresponding physical hardware subsystems. An instance of the virtual execution platform configured to execute the guest OS may be referred to as a virtual machine (VM). In a VM system, an arbitrary number of VMs may execute on a single physical host machine (i.e., a host computer). Each VM may operate independently with respect to other VMs and may communicate with the other VMs, for example, via an emulated network interface. The host computer, through a virtualization layer (e.g., hypervisor) running therein, may be configured with adequate computational and memory resources to support the VMs.

Further, security measures may be implemented in the VMs to combat malicious activities, such as corrupting memory or accessing privileged information. VM integrity tools, implemented in the VMs as in-guest agents (i.e., guest integrity drivers), may be used to inspect the data or content of the VM in real-time. For example, an in-guest agent may monitor events in the VM and selectively report system events to various service appliances, such as a security service appliance configured with anti-virus and anti-malware scanning programs.

### BRIEF DESCRIPTION OF THE DRAWINGS

FIG. 1 is a block diagram of an example system, including a virtualization layer to assist in upgrading an in-guest agent executing in a virtual computing instance (VCI);

FIG. 2 is a sequence diagram illustrating a sequence of events to upgrade an in-guest agent executing in a VCI;

FIG. 3 is a flowchart illustrating an example method for loading an upgraded version of an in-guest agent on a VCI;

FIG. 4A is a flowchart illustrating an example method for backing-up data stored in a first memory region to a second memory region in response to receiving a notification to upgrade an in-guest agent;

FIG. 4B is a flowchart illustrating an example method for retrieving the backed-up data from the second memory region by the upgraded in-guest agent; and

FIG. 5 is a block diagram of an example computing device including non-transitory machine-readable storage medium storing instructions to cause a virtualization layer to assist in upgrading an in-guest agent executing in a VCI.

The drawings described herein are for illustration purposes only and are not intended to limit the scope of the present subject matter in any way.

### DETAILED DESCRIPTION

The paragraphs [0011] to [0013] describe about an overview of guest integrity (GI) drivers, existing methods to upgrade the GI drivers, and drawbacks associated with the existing methods. Virtual computing instances (VCIs) may cover a range of computing functionalities. Example VCIs may include virtual machines (VMs). The VMs, in some examples, may operate with their own guest operating systems on a host computer using resources of the host computer virtualized by a virtualization layer (e.g., a hypervisor, VM monitor, and the like). The tenant (i.e., the owner of the VM) can choose which applications to operate on top of the guest operating system (OS). Further, a security solution may be deployed to provide security to the applications running on the VMs. The security solution may monitor the applications and their processes to protect the applications. For example, a security solution such as AppDefense™ from VMware® uses the virtualization layer (i.e., the hypervisor) to model intended application behavior, monitor for anomalous activity, and provide application control, reputation scoring, security, or the like.

Further, such security solutions may include an in-guest agent (i.e., a guest integrity (GI) driver) executing in the VM. The in-guest agent may perform certain operations for protecting the integrity of the VM. For example, the GI driver may be implemented in the VM to define memory pages (i.e., memory regions) of the VM to be protected. Such protection involves the GI driver requesting that the hypervisor monitor such pages and also requesting to be notified when such pages are written to. Because of the importance of the GI driver, the integrity of the GI driver may have to be protected. In order to protect the integrity of the GI driver, the GI driver executes in a privileged mode, termed “integrity mode”. Requests for protection of the guest OS, made from the GI driver to the hypervisor, can be executed in the integrity mode. The integrity mode may prevent malicious code from masquerading the GI driver and interfering with the guest protection mechanisms by, for example, changing the memory pages being monitored by the hypervisor.

The GI driver may gather context (i.e., sensitive guest OS information) during the VM boot. For example, the context may be OS offsets, global descriptor tables (GDTs), interrupt descriptor tables (IDTs), system service dispatch tables (SSDTs), system callback addresses, and/or the like. Further, the integrity of the VM may be maintained using the gathered context. In some known methods, the GI driver may be upgraded by either restarting the GI driver or by turning off GI security. However, restarting the GI driver may not be feasible as the context gathered during the VM boot may be lost when the GI driver is restarted. Thus, upgrading of the GI driver may have to be stopped until a next reboot of the VM. Further, upgrading of the GI driver by turning off GI security may result in security related issues such as kernel-level attacks or attacks by malicious programs. Also, the GI driver may not be unloaded while maintaining memory allocated to the GI driver as the VM may face the GI driver verifier crash.

Examples described herein may provide an approach to upgrade a GI driver without restarting the GI driver and by maintaining the gathered context untampered. Examples described herein may provide a virtualization layer executing in a host computer to support a VCI. The virtualization layer may receive a message including metadata about a first memory region to be copied and an indication of loading of an upgraded version of the in-guest agent from the in-guest agent. Further, upon receiving the message, the virtualization layer may copy data (e.g., the gathered context as indicated by the metadata) from the first memory region (e.g., the first memory region allocated to the in-guest agent) to a second memory region. Furthermore, the virtualization layer may mark the second memory region as read only memory for the VCI. Furthermore, the virtualization layer may receive information about an entry point of the upgraded version from the in-guest agent. In this example, the in-guest agent may send information about the entry point of the upgraded version, and upon sending the information about the entry point, the in-guest agent may be unloaded itself from the VCI. In this example, since the second memory region is marked as the read only memory, the second memory region may be preserved during unloading of the in-guest agent. The virtualization layer may return a dummy memory release message to the guest OS in response to detecting any request to free up space in the second memory region.

Also, the virtualization layer may receive a request to register the entry point from the upgraded version. Further, the virtualization layer may verify the request based on the information about the entry point. Upon verifying the request, the virtualization layer may enable the upgraded version to enter an integrity mode to monitor the VCI. Also, upon verifying the request, the virtualization layer may enable the upgraded version to copy the data from the second memory region. Thus, examples described herein may enable the virtualization layer to assist in upgrading the in-guest driver and handover the data to the upgraded version securely.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

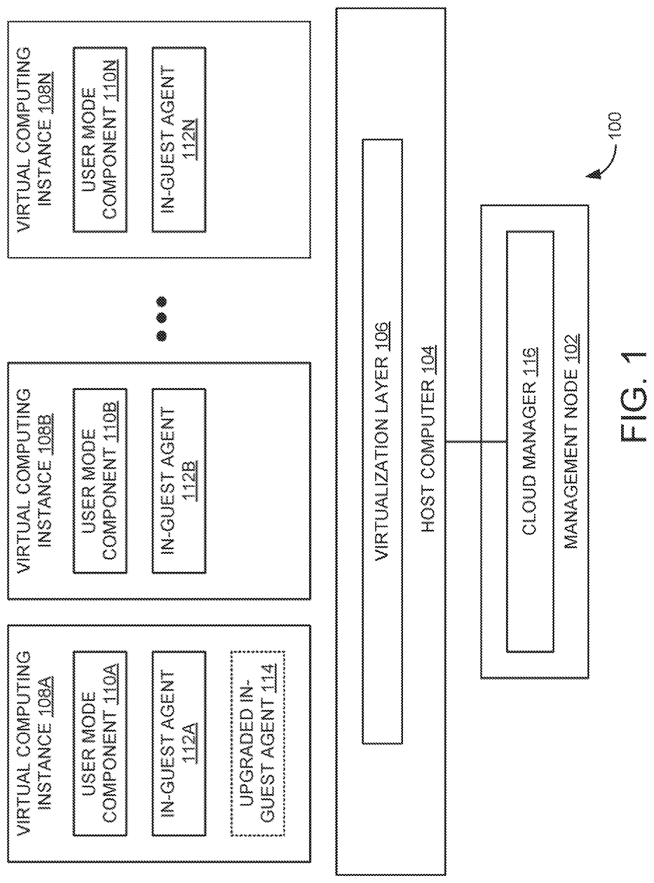

Turning now to the figures, FIG. 1 is a block diagram of an example system 100, including a virtualization layer 106 to assist in upgrading an in-guest agent (e.g., 112A) executing in a virtual computing instance (VCI) (e.g., 108A). Example system 100 may be a virtualized computing environment including multiple data centers. A data center may be a virtual data center. The virtual data center may be a pool or collection of cloud infrastructure resources designed for enterprise needs. Further, the virtual data center may be a virtual representation of a physical data center, complete with servers, storage clusters, and networking components, all of which may reside in virtual space being hosted by one or more physical data centers.

Further, each data center may include multiple host computers. As shown in FIG. 1, system 100 may include a host computer 104. Example host computer 104 may be a physical computer executing different VCIs 108A to 108N. The physical computer may be a hardware-based device (e.g., a personal computer, a laptop, or the like) including an OS. Example VCIs 108A to 108N may be virtual machines (VMs). Further, system 100 may include a virtualization layer 106 (e.g., a hypervisor) executing in host computer 104 to support VCIs 108A to 108N. For example, a VM may operate with its own guest OS on host computer 104 using resources of host computer 104 virtualized by virtualization layer 106. Thus, host computer 104 may execute virtualization layer 106 that creates, runs, and supports VCIs 108A to 108N. Virtualization layer 106 may allocate physical computing resources (e.g., processors, memory, storage, and/or the like) of host computer 104 to each of VCIs 108A to 108N.

Further, system 100 may include in-guest agents 112A to 112N executing in VC's 108A to 108N, respectively, to monitor events (e.g., security events) in VCIs 108A to 108N. The monitored events may be used to manage VCIs 108A to 108N or monitor the performance or security of VCIs 108A to 108N. Furthermore, system 100 may include user mode components 110A to 110N executing in VCIs 108A to 108N, respectively. An example in-guest agent 112A may be a guest integrity driver. The guest integrity driver is loaded within a period during a boot process as provided by a guest OS of VCI 108A. The period may be a window of time configurable between the beginning of the boot process and the end of the boot process. In an example, the guest integrity driver is loaded as a first driver in the boot process of VCI 108A and runs until a shutdown/restart of VCI 108A. Further, the guest integrity driver may collect the data associated with the guest OS during the boot process of VCI 108A. For example, the data may include OS data structures discoveries, callback registrations, system service dispatch tables (SSDT), global descriptor tables (GDT), and the like. In other examples, when the guest integrity driver is not loaded as the first driver in the boot process, then the data associated with the guest OS may be handed over securely to the guest integrity driver by a component loaded first during the boot process.

As shown in FIG. 1, system 100 may include a management node 102 including a cloud manager 116 communicatively connected to host computer 104 via a network. Example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet, or other suitable network system and includes equipment for receiving and transmitting signals.

Example cloud manager 116 may manage different objects/resources in the virtualized computing environment. For example, cloud manager 116 may execute centralized management services that may be interconnected to manage the resources centrally in the virtualized computing environment. Example centralized management service may be a part of vCenter Server™ and vSphere® program products, which are commercially available from Vmware.

During operation, in-guest agent 112A may receive a notification to upgrade in-guest agent 112A from cloud manager 116 in accordance with a defined policy via host computer 104, for instance. Simultaneously, user mode component 110A executing in VCI 108A may receive the notification to upgrade in-guest agent 112A. Further, user mode component 110A may perform loading of an upgraded version 114 of in-guest agent 112A on VCI 108A.

In response to receiving the notification to upgrade in-guest agent 112A, in-guest agent 112A may send the message to virtualization layer 106 indicating loading of an upgraded version 114. In an example, in-guest agent 112A may invoke a hypercall to send the message to virtualization layer 106. An example hypercall may be a request from in-guest agent 112A to virtualization layer 106 asking for a specific functionality to be performed. The hypercall is analogous to a system call, with a transition to virtualization layer 106 (e.g., a hypervisor) instead of to a kernel. Hypercalls, as used herein, include requests directed to virtualization layer 106 of host computer 104, such as requests to access main memory, processors, storage devices, and request to utilize various virtual data center-provided resources (e.g., storage resources, database resources, computing resources, or the like). For example, the guest OS of VCI 108A may use the hypercall to request action or information from virtualization layer 106. The hypercall is used whenever VCI 108A needs to do something only visible by virtualization layer 106, for example, read/write to a particular location.

Further, the message may include metadata about a first memory region to be copied. In an example, in-guest agent 112A may allocate a second memory region in response to receiving the notification. The second memory region may include virtual memory pages such as message object pages. The virtual memory pages may be visible to applications running in VCI 108A. Further, in-guest agent 112A may send an address associated with the allocated second memory region to virtualization layer 106.

Further, virtualization layer 106 may receive the message including metadata about the first memory region to be copied and the indication of loading of upgraded version 114 from in-guest agent 112A. Upon receiving the message, virtualization layer 106 may copy the data from the first memory region to the second memory region. In an example, virtualization layer 106 may receive the address associated with the second memory region from in-guest agent 112A. Further, virtualization layer 106 may designate the second memory region as read only memory for VCI 108A. Upon the designating the second memory region as read only memory, virtualization layer 106 may copy the data from the first memory region as specified by the metadata to the second memory region.

Further, upon upgraded version 114 being loaded on VCI 108A, in-guest agent 112A may detect an entry point of upgraded version 114. The entry point may include a specific instruction pointer address or a combination of the instruction pointer address and a virtual central processing unit (vCPU) identifier. Furthermore, in-guest agent 112A may send information about the entry point of upgraded version 114 to virtualization layer 106 in response to the detection. Further, upon sending the information about the entry point of upgraded version 114 to virtualization layer 106, in-guest agent 112A may be unloaded itself from VCI 108A. In this example, the data in the second memory region is preserved during the unloading of in-guest agent 112A since the second memory region is marked as read only memory for VCI 108A.

Further, virtualization layer 106 may receive the information about the entry point of upgraded version 114 from in-guest agent 112A. Further, virtualization layer 106 may receive a request to register the entry point from upgraded version 114. Furthermore, virtualization layer 106 may verify the request based on the information about the entry point received from in-guest agent 112A. Upon verifying the request, virtualization layer 106 may enable upgraded version 114 of in-guest agent 112A to enter an integrity mode to monitor VCI 108A. Further, upon enabling upgraded version 114 to enter the integrity mode, virtualization layer 106 may record the entry point of upgraded version 114. For example, to prevent malicious code from hijacking the mechanism for requesting protection of memory pages, requests to protect memory pages will only be executed by virtualization layer 106 if executed from an elevated privilege mode referred to herein as the “integrity mode.” Only upgraded version 114 may enter the integrity mode. To prevent malicious code from entering the integrity mode, upgraded version 114 may initialize the integrity mode by specifying an integrity mode entry point. The integrity mode can be entered via a specific request that is executed from the specified entry point.

Upon upgraded version 114 entering the integrity mode, virtualization layer 106 may enable upgraded version 114 to copy the data from the second memory region. In an example, virtualization layer 106 may determine whether the stored data is available in the second memory region. Further, virtualization layer 106 may send an address associated with the second memory region to upgraded version 114. Furthermore, virtualization layer 106 may enable upgraded version 114 to copy the data from the second memory region based on the address. For example, virtualization layer 106 may enable upgraded version 114 to copy the data (i.e., the guest OS information) from the second memory region to a third memory region accessible or allocated to upgraded version 114.

Further, virtualization layer 106 may receive a notification indicating that the copying of the data from the second memory region is successful from upgraded version 114. Further, virtualization layer 106 may free up space in the second memory region by deleting the data from the second memory region. Furthermore, upon copying the data from the second memory region, upgraded version 114 may remap the copied data to an associated object. Thus, the data associated with in-guest agent 112A may be backed-up and then provided to upgraded version 114 securely.

In some examples, the functionalities described in FIG. 1, in relation to instructions to implement functions of user mode components 110A to 110N, in-guest agents 112A to 112N, upgraded in-guest agent 114, virtualization layer 106, cloud manager 116, and any additional instructions described herein in relation to the storage medium, may be implemented as engines or modules including any combination of hardware and programming to implement the functionalities of the modules or engines described herein. The functions of user mode components 110A to 110N, in-guest agents 112A to 112N, upgraded in-guest agent 114, virtualization layer 106, and cloud manager 116 may also be implemented by a respective processor. In examples described herein, the processor may include, for example, one processor or multiple processors included in a single device or distributed across multiple devices. Further, examples described herein may be implemented in products such as VMWare® AppDefense, which can enhance the security of application hosts (i.e., VCIs) running on a host computer.

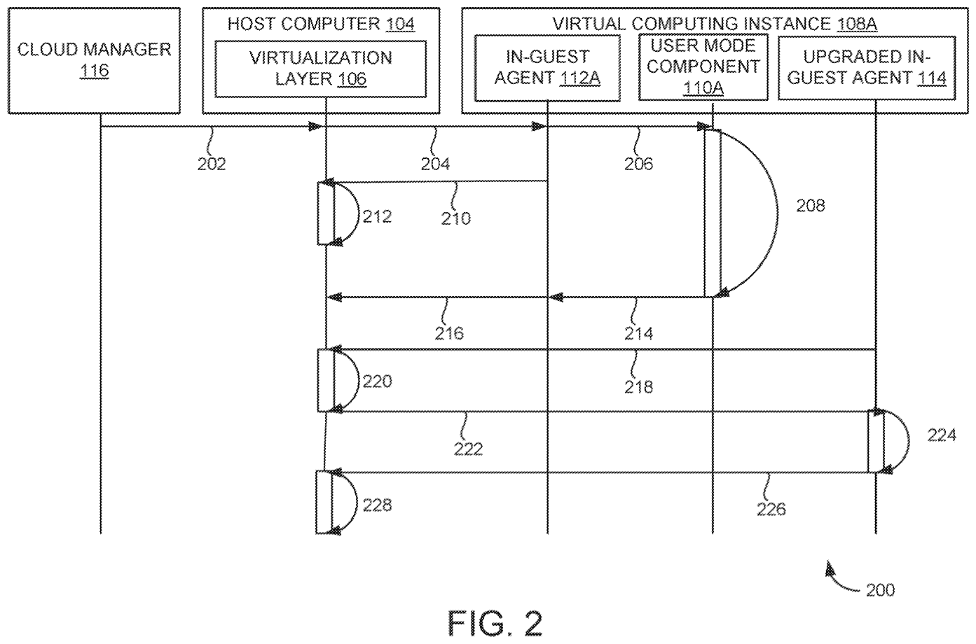

FIG. 2 is a sequence diagram 200 illustrating a sequence of events to upgrade an in-guest agent (e.g., in-guest agent 112A of FIG. 1) executing in a VCI (e.g., VCI 108A of FIG. 1). For example, similarly named elements of FIG. 2 may be similar in structure and/or function to elements described with respect to FIG. 1. Sequence diagram 200 may represent the interactions and the operations involved in upgrading in-guest agent 112A in VCI 108A. FIG. 2 illustrates process objects including cloud manager 116, virtualization layer 106, in-guest agent 112A, user mode component 110A, and upgraded in-guest agent 114 along with their respective vertical lines originating from them. The vertical lines of cloud manager 116, virtualization layer 106, in-guest agent 112A, user mode component 110A, and upgraded in-guest agent 114 may represent the processes that may exist simultaneously. The horizontal arrows (e.g., 202, 204, 206, 210, 214, 216, 218, 222, and 226) may represent the data flow steps between the vertical lines originating from their respective process objects (e.g., cloud manager 116, virtualization layer 106, in-guest agent 112A, user mode component 110A, and upgraded in-guest agent 114). Further, activation boxes (e.g., 208, 212, 220, 224, and 228) between the horizontal arrows may represent the process that is being performed in the respective process object.

At 202, cloud manager 116 may send a notification to upgrade in-guest agent 112A to host computer 104. Further, the notification may be communicated to in-guest agent 112A and user mode component 110A, at 204 and 206, respectively. Upon receiving the notification, user mode component 110A may perform loading of upgraded version 114 of in-guest agent 112A on VCI 108A, at 208. In an example, user mode component 110A may download an upgrade package in response to the notification from cloud manager 116 and initiate an installation of the upgrade package in VCI 108A.

At 210, in response to receiving the notification, in-guest agent 112A may send a message to virtualization layer 106 indicating loading of the upgraded version. Also, the message may include metadata about a first memory region to be copied. Further, in-guest agent 112A may allocate a second memory region and send an address associated with the allocated second memory region to virtualization layer 106. The allocated second memory region may be visible/accessible to applications running inside VCI 108A. In an example, in-guest agent 112A may use a hypercall mechanism to inform virtualization layer 106 that in-guest agent 112A is being upgraded.

At 212, upon receiving the message and the address associated with the second memory region, virtualization layer 106 may copy data from the first memory region to the second memory region. At 214, in-guest agent 112A may detect an entry point of upgraded version 114 using user mode component 110A. At 216, in-guest agent 112A may send information about the entry point of upgraded version 114 to virtualization layer 106. At 218, virtualization layer 106 may receive a request to register the entry point from upgraded version 114.

At 220, virtualization layer 106 may verify the request based on the information about the entry point. At 222, upon verifying the request, virtualization layer 106 may enable upgraded version 114 to enter an integrity mode to monitor VCI 108A. Further at 222, virtualization layer 106 may enable upgraded version 114 to copy the data from the second memory region. At 224, upgraded version 114 copies the data from the second memory region. At 226, upgraded version 114 sends a notification to virtualization layer 106 indicating that the copying of the data from the second memory region to a third memory region accessible or allocated to upgraded version 114 is successful. Upon receiving the notification from the upgraded version 114, virtualization layer 106 may free up space in the second memory region by deleting the data from the second memory region, at 228.

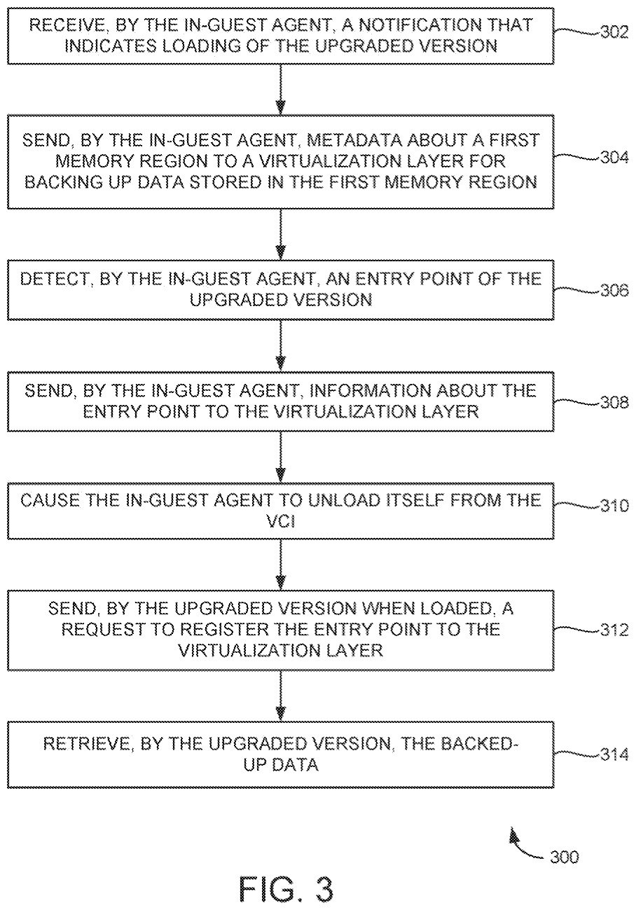

FIG. 3 is a flowchart illustrating an example method 300 for loading an upgraded version of an in-guest agent on a VCI. At 302, a notification that indicates loading of the upgraded version may be received by the in-guest agent. For example, the in-guest agent may be a guest integrity driver. The guest integrity driver may be loaded within a period during a boot process as provided by a guest OS of the VCI. The period may refer to a window of time configurable between the beginning of the boot process and the end of the boot process. In an example, the guest integrity driver is loaded as a first driver in a boot process of the VCI and runs until a shutdown/restart of the VCI. The guest integrity driver may collect the data associated with the guest OS during the boot process of the VCI.

At 304, upon receiving the notification by the in-guest agent, metadata about a first memory region may be sent, by the in-guest agent, to a virtualization layer for backing-up data stored in the first memory region. In an example, sending the metadata about the first memory region to be backed-up to the virtualization layer may include:
allocating, by the in-guest agent, a second memory region in response to receiving the notification.
sending, by the in-guest agent, an address associated with the allocated second memory region to the virtualization layer. The virtualization layer may designate the allocated second memory region as read only memory for the VCI.
sending, by the in-guest agent, the metadata about the first memory region to the virtualization layer. The virtualization layer may back-up the data stored in the first memory region to the allocated second memory region.

At 306, an entry point of the upgraded version may be detected by the in-guest agent. At 308, information about the entry point may be sent to the virtualization layer by the in-guest agent. At 310, upon sending the information, the in-guest agent may be unloaded itself from the VCI. At 312, a request to register the entry point may be sent, by the upgraded version when loaded, to the virtualization layer.

At 314, upon a verification of the request by the virtualization layer, the backed-up data may be retrieved, by the upgraded version, from the second memory region. In an example, retrieving the backed-up data may include:
upon the verification of the request by the virtualization layer, receiving, by the upgraded version, an address associated with the second memory region from the virtualization layer, and
retrieving, by the upgraded version, the backed-up data from the second memory region using the received address.

Further, example method 300 may include sending, by the upgraded version, a notification to the virtualization layer to indicate that the retrieval of the data from the second memory region is successful. In an example, upon receiving the notification, the virtualization layer may free up space in the second memory region by deleting the data from the second memory region. Further, example method 300 may include mapping, by the upgraded version, the retrieved backed-up data to an object associated with the upgraded version.

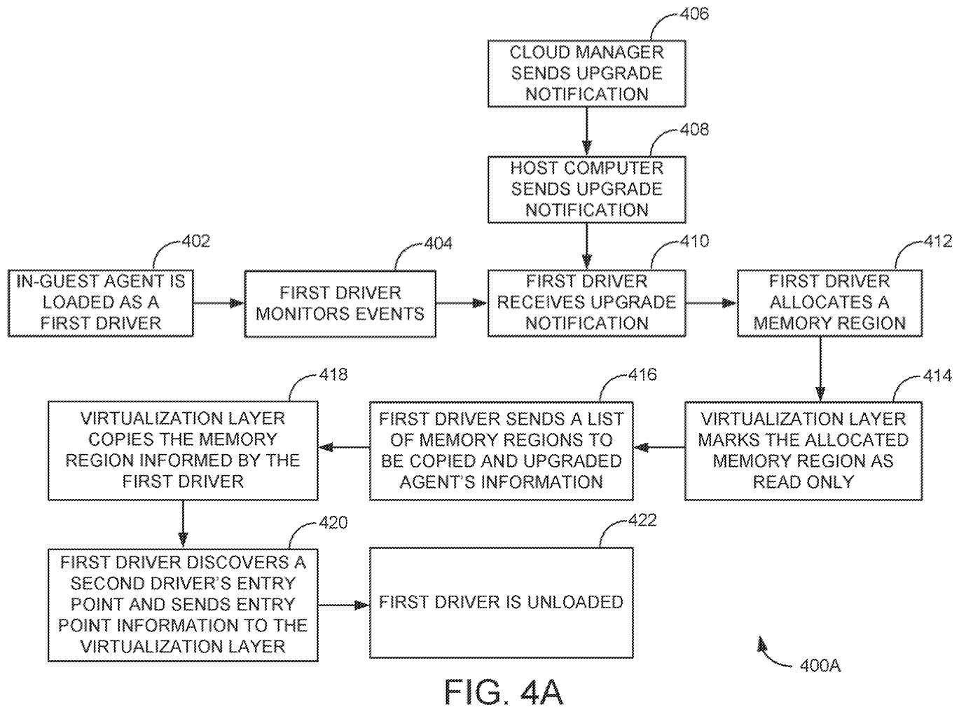

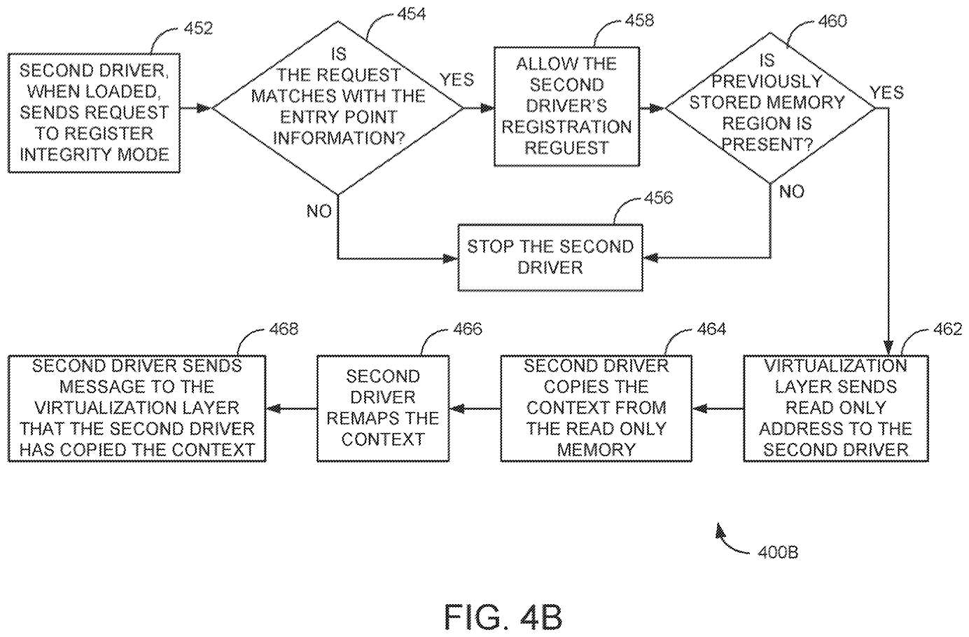

FIG. 4A is a flowchart illustrating an example method 400A for backing-up data or context stored in a first memory region to a second memory region in response to receiving a notification to upgrade an in-guest agent (e.g., a GI driver). At 402, the in-guest agent may be loaded as a first driver in a boot process of a VCI. In order for an entry point itself to be trusted, the GI driver, when loaded, provides an indication of this entry point in the boot process. Some operating systems, such as Microsoft Windows, provide a window of time early in the boot-up process to execute security software. By providing this window early in the boot process, the OS provides a level of certainty that no malicious software has tampered with the OS or with the GI driver. Additionally, software executed during this period of time is required to be certified by the OS developer, thus ensuring that such software is not malicious. Defining the entry point for integrity mode at the beginning of the boot-up process may ensure that no malicious software has interfered with the mechanism for entering integrity mode, such as by “hijacking” the mechanism for setting the entry point.

At 404, the first driver may locate and secure different guest integrity data or context (e.g., guest OS information) during the guest OS boot process (e.g., the VCI boot process). In an example, the guest integrity data or context may include sensitive guest OS information, such as OS offsets, IDTs, SSDTs, system callback addresses, and the like, gathered during the guest OS boot process. Further, integrity of the VCI may be maintained using a guest-integrity data and code monitoring feature until a completion of a lifecycle of the VCI.

At 406, a cloud manager may send a notification to a host computer (e.g., that executes the VCI) indicating that an upgraded version of the first driver may have to be implemented in the VCI via a policy. The cloud manager may refer to management software to collect information from the first driver and may be responsible for upgrading the first driver and generating a protection policy. At 408, the host computer may send the notification to the first driver. Accordingly, the first driver receives the notification, at 410. In an example, the first driver may have callbacks registered for the first driver mapped to the VCI, so that the first driver receives a callback stating that there is an updated version to be loaded. Further, a user mode component executing in the VCI may initialize upgrading of the first driver (i.e., the upgraded version of the first driver is hereinafter referred to as a second driver). Upon receiving the notification, the first driver may allocate a memory region (e.g., memory pages) to dump the guest integrity data or context associated with the first driver and send an address associated with the memory region to a virtualization layer using a hypercall, at 412.

At 414, the virtualization layer may mark the allocated memory region as read only for the VCI. At 416, the first driver may send a list of memory regions to the virtualization layer. The list of memory regions may have to be backed-up on the allocated memory region. At 418, the virtualization layer may copy the guest integrity data or context in the list of memory regions to the allocated memory region in a format such as a key length value (KLV) format, for instance.

At 420, the first driver may discover the second driver's entry point and communicate entry point information associated with the second driver to the virtualization layer. At 422, the first driver is unloaded from the VCI. In an example, during the unloading of the first driver, the virtualization layer may detect a call to free up space in the allocated memory region (i.e., to delete the stored guest integrity data or context from the allocated memory region) and return a dummy memory release message to the VCI. Thus, example method 400A may securely save the guest integrity data or context associated with the first driver by preserving the guest integrity data or context in the allocated memory region during the unloading of the first driver.

FIG. 4B is a flowchart illustrating an example method 400B for retrieving the backed-up guest integrity data or context stored in the allocated memory region by the upgraded in-guest agent (i.e., the second driver). At 452, upon the loading of the second driver, the second driver may send a request to the virtualization layer to register an integrity mode entry point. The term “entry point” may refer to an instruction address from where the second driver enters into the integrity mode to monitor the VCI. At 454, a check may be made by the virtualization layer to determine whether the second driver's entry point is same as the entry point information communicated by the first driver. When the second driver's entry point is different from the entry point information communicated by the first driver, the virtualization layer may stop the second driver from registration, at 456.

When the requesting second driver's entry point is same as the entry point information communicated by the first driver, at 458, the virtualization layer may allow the second driver's registration request and record the integrity mode entry point of the second driver. At 460, a check may be made by the virtualization layer to determine a presence of the stored guest integrity data or context in the allocated memory region. When the stored guest integrity data or context is not present, the virtualization layer may stop the second driver, at 456. When the stored guest integrity data or context is present, at 462, the virtualization layer may send the address associated with the allocated memory region to the second driver.

At 464, the second driver may copy the guest integrity data or context from the allocated memory region using the address received from the virtualization layer. Further, the second driver may remap the guest integrity data or context to objects (e.g., IDT, GDT, callback registrations, and the like) associated with the second driver using a format such as a KLV format, at 466. At 468, the second driver may send a message to the virtualization layer that the guest integrity data or context is copied. Upon receiving the message, the virtualization layer may free up space in the allocated memory region. Thus, example method 400B may securely hand over the guest integrity data or context of the first driver to the second driver.

In an example, the methods 300, 400A, and 400B depicted in FIGS. 3, 4A, and 4B, respectively, may represent generalized illustrations. Other processes may be added, or existing processes may be removed, modified, or rearranged without departing from the scope and spirit of the present application. In addition, the methods 300, 400A, and 400B may represent instructions stored on a computer-readable storage medium that, when executed, may cause a processor to respond, for example, to perform actions, to change states, and/or to make decisions. The methods 300, 400A, and 400B may represent functions and/or actions performed by functionally equivalent circuits like analog circuits, digital signal processing circuits, application specific integrated circuits (ASICs), or other hardware components associated with the system. Furthermore, methods 300, 400A, and 400B are not intended to limit the implementation of the present application. Rather, example methods 300, 400A, and 400B may illustrate functional information to design/fabricate circuits, generate machine-readable instructions, or use a combination of hardware and machine-readable instructions to perform the illustrated processes.

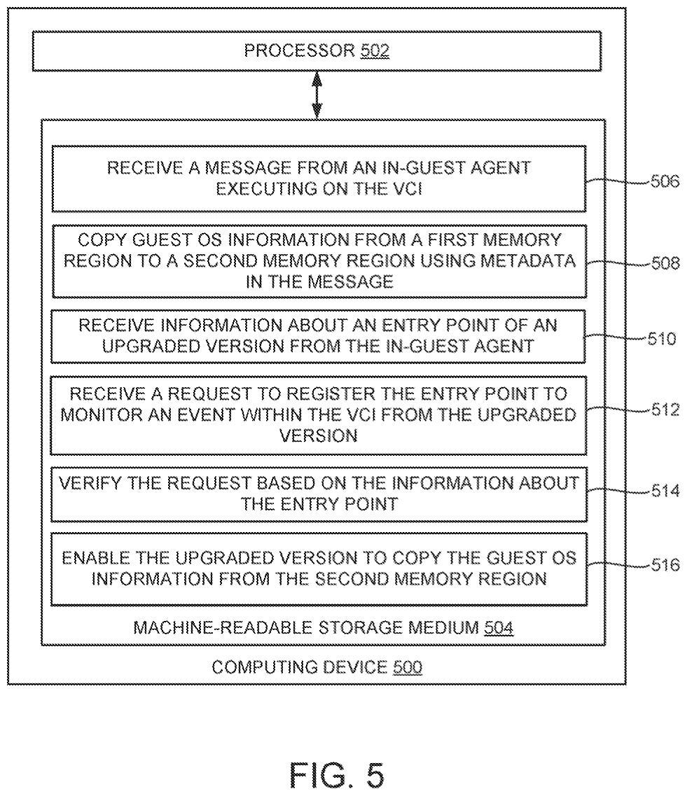

FIG. 5 is a block diagram of an example computing device 500 including a non-transitory machine-readable storage medium on which is stored instructions to assist in upgrading an in-guest agent running in a VCI. In an example, computing device 500 may include a virtualization layer that supports execution of the VCI. An example in-guest agent is a guest integrity driver. In an example, the guest integrity driver is loaded as a first driver in the boot process of the VCI and runs until a shutdown/restart of the VCI. The guest integrity driver may be used to collect the guest OS information during the boot process of the VCI.

Further, computing device 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions for execution by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 504 may be remote but accessible to computing device 500.

Machine-readable storage medium 504 may store instructions 506-516. In an example, instructions 506-516 may be executed by processor 502 to assist in upgrading of the in-guest agent. Instructions 506 may be executed by processor 502 to cause the virtualization layer to receive a message from the in-guest agent executing on the VCI. In an example, the message may include metadata about a first memory region to be copied and an indication of loading of an upgraded version of the in-guest agent.

Instructions 508 may be executed by processor 502 to cause the virtualization layer to copy guest OS information from the first memory region to a second memory region using the metadata. In an example, instructions to copy the guest OS information from the first memory region to the second memory region may include instructions to:
cause the virtualization layer to receive an address associated with the second memory region from the in-guest agent. In an example, instructions to cause the virtualization layer to receive the address associated with the second memory region may include instructions to cause the virtualization layer to receive the address associated with the second memory region from the in-guest agent via an invocation of a hypercall from the in-guest agent.
cause the virtualization layer to designate the second memory region as read only for the VCI.
cause the virtualization layer to copy the guest OS information as specified by the metadata from the first memory region to the second memory region. In an example, instructions to cause the virtualization layer to copy the guest OS information from the first memory region to the second memory region may include instructions to cause the virtualization layer to copy the guest OS information from the first memory region to the second memory region in a data encoding format. An example data encoding format may include a Key length Value (KLV) format.

Instructions 510 may be executed by processor 502 to cause the virtualization layer to receive information about an entry point of the upgraded version from the in-guest agent. In this example, the in-guest agent sends the information about the entry point to the virtualization layer. Upon sending the information about the entry point, machine-readable storage medium 504 may store instructions to cause the in-guest agent to unload itself from the VCI. Instructions 512 may be executed by processor 502 to cause the virtualization layer to receive a request to register the entry point to monitor an event in the VCI from the upgraded version. An example event may include a security event that can be used to manage the VCI or monitor the performance or security of the VCI. In other examples, the upgraded version may also request to register the entry point to monitor any other events associated with the VCI (e.g., an upgrade event in the VCI, a process running in the VCI, a software module installed in the VCI, and the like). Instructions 514 may be executed by processor 502 to cause the virtualization layer to verify the request based on the information about the entry point.

Upon verifying the request, instructions 516 may be executed by processor 502 to cause the virtualization layer to enable the upgraded version to copy the guest OS information from the second memory region. In an example, instructions to cause the virtualization layer to enable the upgraded version to copy the guest OS information from the second memory region may include instructions to cause the virtualization layer to:
upon verifying the request, enable the upgraded version of the in-guest agent to enter an integrity mode to monitor the event,
upon enabling the upgraded version to monitor the event, record the entry point of the upgraded version, and
enable the upgraded version to copy the guest OS information from the second memory region to a third memory region accessible to the upgraded version.

Instructions to cause the virtualization layer to enable the upgraded version to copy the guest OS information from the second memory region may include instructions to cause the virtualization layer to:
upon verifying the request, send an address associated with the second memory region to the upgraded version, and
enable the upgraded version to copy the guest OS information from the second memory region using the address associated with the second memory region.

Furthermore, machine-readable storage medium 504 may store instructions to cause the virtualization layer to receive a notification from the upgraded version indicating that the copying of the guest OS information from the second memory region is successful. Upon receiving the notification, machine-readable storage medium 504 may store instructions to cause the virtualization layer to free up space in the second memory region by deleting the guest OS information from the second memory region. Thus, examples described herein may use a hypercall mechanism to inform a virtualization layer (e.g., a hypervisor) that a guest-integrity driver is being upgraded, so the context associated with the guest-integrity driver can be backed-up before tear down and the backed-up context may be handed over to an upgraded guest-integrity driver. Examples described herein may upgrade the guest integrity driver without a reboot of the VCI in secure way and without losing the guest OS information or context.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a host computer;
a virtual computing instance (VCI) running on the host computer;
a virtualization layer executing in the host computer to support the VCI; and
an in-guest agent executing in the VCI to monitor an event, wherein the virtualization layer is to:
receive, from the in-guest agent, a message including metadata about a first memory region to be copied and an indication of loading of an upgraded version of the in-guest agent;
upon receiving the message, copy data from the first memory region to a second memory region;
receive information about an entry point of the upgraded version from the in-guest agent;
receive a request to register the entry point from the upgraded version;
verify the request based on the information about the entry point; and
upon verifying the request, enable the upgraded version to copy the data from the second memory region.

2. The system of claim 1, wherein the in-guest agent is a guest integrity driver, wherein the guest integrity driver is loaded within a period during a boot process as provided by a guest operating system (OS) of the VCI, and wherein the period is a window of time configurable between a beginning of the boot process and an end of the boot process.

3. The system of claim 2, wherein the guest integrity driver is to collect the data associated with the guest OS during the boot process of the VCI.

4. The system of claim 1, wherein the in-guest agent is to:
receive a notification to upgrade the in-guest agent from a cloud manager in accordance with a defined policy; and
in response to receiving the notification, send the message to the virtualization layer indicating loading of the upgraded version.

5. The system of claim 4, wherein the in-guest agent is to:
allocate the second memory region in response to receiving the notification; and send an address associated with the allocated second memory region to the virtualization layer, and wherein the virtualization layer, upon receiving the address associated with the second memory region, is to:
designate the second memory region as read only memory for the VCI; and
upon designating the second memory region, copy the data from the first memory region as specified by the metadata to the second memory region.

6. The system of claim 1, wherein the in-guest agent is to:
upon the upgraded version being loaded on the VCI, detect the entry point of the upgraded version;
send the information about the entry point of the upgraded version to the virtualization layer in response to the detection; and
unload itself from the VCI upon sending the information about the entry point.

7. The system of claim 1, wherein the virtualization layer is to:
upon verifying the request, enable the upgraded version of the in-guest agent to enter an integrity mode to monitor the VCI;
upon enabling the upgraded version to enter the integrity mode, record the entry point of the upgraded version; and
enable the upgraded version to copy the guest OS information from the second memory region to a third memory region accessible to the upgraded version.

8. The system of claim 1, wherein the virtualization layer is to:
determine whether the stored data is available in the second memory region;
send an address associated with the second memory region to the upgraded version; and
enable the upgraded version to copy the data from the second memory region based on the address.

9. A non-transitory computer-readable storage medium storing instructions executable by a computing device having a virtualization layer that supports execution of a virtual computing instance (VCI), to cause the virtualization layer to:
receive a message from an in-guest agent executing on the VCI, the message including metadata about a first memory region to be copied and an indication of loading of an upgraded version of the in-guest agent;
copy guest operating system (OS) information from the first memory region to a second memory region using the metadata;
receive information about an entry point of the upgraded version from the in-guest agent;
receive a request to register the entry point to monitor an event in the VCI from the upgraded version;
verify the request based on the information about the entry point; and
upon verifying the request, enable the upgraded version to copy the guest OS information from the second memory region.

10. The non-transitory computer-readable storage medium of claim 9, further comprising instructions executable by the computing device to cause the virtualization layer to:
receive a notification, from the upgraded version, indicating that the copying of the guest OS information from the second memory region is successful; and
free up space in the second memory region by deleting the guest OS information from the second memory region.

11. The non-transitory computer-readable storage medium of claim 9, wherein instructions to cause the virtualization layer to copy the guest OS information from the first memory region to the second memory region comprise instructions to cause the virtualization layer to:
receive an address associated with the second memory region from the in-guest agent;
designate the second memory region as read only for the VCI; and
upon designating the second memory region, copy the guest OS information as specified by the metadata from the first memory region to the second memory region.

12. The non-transitory computer-readable storage medium of claim 11, wherein instructions to cause the virtualization layer to receive the address associated with the second memory region comprise instructions to cause the virtualization layer to:
receive the address associated with the second memory region from the in-guest agent via an invocation of a hypercall from the in-guest agent.

13. The non-transitory computer-readable storage medium of claim 9, wherein the in-guest agent is a guest integrity driver, wherein the guest integrity driver is loaded as a first driver in a boot process of the VCI, and wherein the guest integrity driver is to collect the guest OS information during the boot process of the VCI.

14. The non-transitory computer-readable storage medium of claim 9, wherein instructions to cause the virtualization layer to copy the guest OS information from the first memory region to the second memory region comprise instructions to cause the virtualization layer to:
copy the guest OS information from the first memory region to the second memory region in a data encoding format, wherein the data encoding format comprises a Key length Value (KLV) format.

15. The non-transitory computer-readable storage medium of claim 9, further comprising instructions executable by the computing device to:
cause the in-guest agent to send the information about the entry point of the upgraded version to the virtualization layer; and
upon sending the information about the entry point, cause the in-guest agent to unload itself from the VCI.

16. The non-transitory computer-readable storage medium of claim 9, wherein instructions to cause the virtualization layer to enable the upgraded version to copy the guest OS information from the second memory region comprise instructions to cause the virtualization layer to:
upon verifying the request, enable the upgraded version of the in-guest agent to enter an integrity mode to monitor the event;
upon enabling the upgraded version to monitor the event, record the entry point of the upgraded version; and
enable the upgraded version to copy the guest OS information from the second memory region to a third memory region accessible to the upgraded version.

17. A method for loading an upgraded version of an in-guest agent on a virtual computing instance (VCI) executing in a host computer, the method comprising:
receiving, by the in-guest agent, a notification that indicates loading of the upgraded version;
upon receiving the notification, sending, by the in-guest agent, metadata about a first memory region to a virtualization layer for backing-up data stored in the first memory region;
detecting, by the in-guest agent, an entry point of the upgraded version;
sending, by the in-guest agent, information about the entry point to the virtualization layer;
upon sending the information, causing the in-guest agent to unload itself from the VCI;
sending, by the upgraded version when loaded, a request to register the entry point to the virtualization layer; and
retrieving, by the upgraded version, the backed-up data upon a verification of the request.

18. The method of claim 17, wherein sending the metadata about the first memory region to be backed-up to the virtualization layer comprises:
allocating, by the in-guest agent, a second memory region in response to receiving the notification;
sending, by the in-guest agent, an address associated with the allocated second memory region to the virtualization layer, wherein the virtualization layer is to designate the allocated second memory region as read only memory for the VCI; and
sending, by the in-guest agent, the metadata about the first memory region to the virtualization layer, wherein the virtualization layer is to back-up the data stored in the first memory region to the allocated second memory region.

19. The method of claim 17, wherein retrieving the backed-up data upon the verification of the request comprises:
receiving, by the upgraded version, an address associated with a second memory region from the virtualization layer upon the verification of the request by the virtualization layer; and
retrieving, by the upgraded version, the backed-up data from the second memory region using the received address.

20. The method of claim 17, further comprising:
mapping, by the upgraded version, the retrieved backed-up data to an object associated with the upgraded version.
